(19) United States
(12) Patent Application Publication
(10) Pub. No.: US 2026/0203357 A1
(43) Pub. Date: Jul. 16, 2026

(54) CREATING SELF-DETERMINATIVE DOCUMENTS

(71) Applicant: FACTIFY TECHNOLOGIES INC., Dover, DE (US)

(72) Inventors: Matan Gavish, Givat Ada (IL); Gil Asher, Binyamina (IL)

(21) Appl. No.: 19/562,718

(22) Filed: Mar. 10, 2026

Related U.S. Application Data
(63) Continuation of application No. PCT/US2025/033561, filed on Jun. 13, 2025.
(60) Provisional application No. 63/002,016, filed on Mar. 30, 2020.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.

(51) Int. Cl. G06F 16/93; G06F 16/16; G06F 16/178

(52) U.S. Cl. CPC G06F 16/93; G06F 16/162; G06F 16/1794

(57) ABSTRACT

A system and method for creating self-determinative documents. The described technology provisions documents with embedded intelligence that enables self-determination, allowing for remote control, secure access, and dynamic interaction across platforms. This system includes a physical processor and memory to execute embedded intelligence, facilitating document lifecycle management, access control, and data integrity. The method involves receiving a request to create a self-determinative document, provisioning the document with intelligence, storing data, and providing remote access.

### PRIORITY CLAIMS TO RELATED APPLICATIONS

This application is a continuation application of and claims priority to International Patent Application No. PCT/US25/33561 filed Jun. 13, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63,713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, and U.S. Provisional Patent Application 63/800,869, filed May 6, 2025, and U.S. Provisional Patent Application 63/822,629 filed Jun. 12, 2025, each of which this application claims benefit and priority of, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, and U.S. Provisional Patent Application 64/002,016, filed Mar. 10, 2026, each of which are incorporated herein in their entirety by these references.

### BACKGROUND

In today's digital age, electronic documents are widespread, serving as the backbone of communication and information exchange across various industries. These documents, often stored in formats such as PDF, Word, or Excel, are typically shared and accessed through local, shared, or cloud storage systems. However, once these documents are distributed, the original owner or creator often loses control over the documents, leading to potential security risks and unauthorized dissemination. This loss of control is particularly concerning for organizations that handle sensitive information, as these organizations depend heavily on the goodwill of recipients and the legal system to ensure compliance with confidentiality agreements and data protection policies.

Despite the availability of document management systems and access control mechanisms, these solutions often fall short in providing comprehensive control and security. They typically offer pseudo-control through policies and procedures, which can be easily circumvented. Moreover, the proliferation of electronic documents across various platforms and devices exacerbates the challenge of maintaining a single, true version of a document, leading to issues with version control and data integrity. There is a pressing need for a more robust system that enables document owners to maintain control over their documents, ensuring secure access and interaction while preventing unauthorized distribution and modification.

### SUMMARY

As will be described in greater detail below, the present disclosure describes a system, method, and computer-readable medium for managing electronic documents as smart digital objects, utilizing an embedded API to enable remote control, secure access, and dynamic interaction across various platforms.

In one embodiment, the disclosure includes a method comprising receiving a request to create a document capable of self-governance; provisioning, in response to the request, the document with embedded intelligence that enables the document to govern itself; receiving, via the embedded intelligence, data to store within the document; and providing, via a computing system executing the embedded intelligence, remote access to the data through the embedded intelligence.

In another embodiment, the disclosure includes a method wherein the request to create the self-governing document comprises a request to convert an existing document that comprises a data file into the self-governing document; and receiving the data to store within the self-governing document comprises copying, via the embedded intelligence, the data into the self-governing document. The method further comprises deleting the existing document after copying the data of the existing document to the self-governing document; receiving a request to recover the deleted document; and providing, in response to the request to recover the deleted document, access to the data via a recreated document that has the same file type as the deleted document.

In a third embodiment, the disclosure includes a method wherein the request to convert the existing document involves identifying, within a file management system, multiple documents for conversion, and these documents include the existing document. The method further involves performing a deduplication process by identifying an additional copy of the existing document within the multiple documents; assessing that the presence of the additional copy of the existing document suggests an additional access right to the data of the existing document; and enabling, through the embedded intelligence of the self-governing document, the additional access right to the data.

In another embodiment, the disclosure includes a method wherein the request to convert the existing document is triggered automatically when the document is opened. The method further comprises a request to include a portion of data from an existing document in the self-governing document and to leave a different portion of the data within the existing document; and receiving the data to store within the self-governing document comprises receiving the portion of the data from the existing document.

In yet another embodiment, the disclosure includes a system comprising at least one physical processor; physical memory comprising computer-executable instructions that, when executed by the physical processor, cause the physical processor to receive a request to create a document capable of self-determination; provision, in response to the request, the document by embedding intelligence that enables the document to determine its own characteristics; receive, via the embedded intelligence, data to store within the document; and provide, via a computing system executing the embedded intelligence, remote access to the data through the embedded intelligence.

In another embodiment, the disclosure includes a non-transitory computer-readable medium comprising computer-executable instructions that, when executed by at least one processor of a computing device, cause the computing device to receive a request to create a document capable of self-determination; provision, in response to the request, the document by embedding intelligence that enables the document to determine its own state; receive, via the embedded intelligence, data to store within the document; and provide, via a computing system executing the embedded intelligence, remote access to the data through the embedded intelligence. These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a system diagram illustrating the architecture for managing electronic documents as smart digital objects.

FIG. 2 illustrates a system diagram of a networked document management system.

FIG. 3 illustrates a flow chart diagram of a method for creating and managing a document with embedded intelligence that can make decisions independently.

FIG. 4 is a flow chart diagram illustrating a method for managing the deletion and recovery of electronic documents.

FIG. 5 is a flow chart diagram illustrating a method for managing access rights to data within documents that determine their own access rights.

FIG. 6 is a flow chart diagram illustrating a method for selectively incorporating data from an existing document into a document that determines its own content.

FIG. 7 illustrates a flow chart diagram of a method for determining user activity and converting documents.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The traditional paradigm of electronic documents is deeply rooted in the legacy of Gutenberg's printing press—a revolutionary invention that transformed the dissemination of information by creating physical, static documents. However, as technology has evolved, the digital space has largely replicated this paradigm, treating electronic documents as mere recreations of their physical counterparts. PDFs, Word files, and other formats are essentially digital versions of printed pages, constrained by the same static nature that defined physical documents for centuries. This translation on the Gutenberg paradigm into the digital realm has limited the potential of electronic documents, tethering them to outdated concepts of form, function, location, ownership, and control. The concepts described herein enable breaking free from this paradigm and embracing a new era of smart documents with embedded intelligence—a transformative framework that redefines what documents can be and how they interact with the digital world.

### Breaking Free From the Gutenberg Paradigm

As noted, the Gutenberg paradigm assumes that documents are static entities, designed to be read, printed, and archived. Even in their digital form, electronic documents are treated as fixed layouts, with no inherent ability to interact dynamically with their environment. This approach ignores the transformative potential of digital technology, which allows for interactivity, adaptability, and integration. Electronic documents do not need to be tied to the limitations of physical documents; they can evolve into intelligent entities capable of managing their lifecycle, interacting with users and systems, and adapting to changing contexts. By embedding intelligence into documents, we can create a new paradigm that leverages the full capabilities of the digital space. The advantages of smart documents with embedded intelligence may include dynamic interaction, granular access control, real-time data synchronization, lifecycle management, enhanced collaboration, improved efficiency, and advanced security.

### Dynamic Interaction

Smart documents that are transformed as discussed herein are no longer static files but active participants in digital ecosystems. They can interact dynamically with users, systems, and other documents, enabling real-time updates, collaboration, and integration. For example, a smart contract can automatically enforce terms, track compliance, and update stakeholders without manual intervention. This dynamic interaction eliminates the need for repetitive tasks and ensures that documents remain relevant and up-to-date.

### Granular Access Control

Unlike traditional electronic documents, which rely on external systems for access control, smart documents can enforce permissions at the content level. Embedded intelligence allows documents to determine who can view, edit, or share specific sections based on user roles, security clearances, or contextual inputs. For instance, a legal document can restrict access to sensitive clauses for unauthorized users while allowing full access for attorneys. This granular control enhances security and ensures compliance with organizational policies.

### Real-Time Data Synchronization

Smart documents can integrate with external systems to synchronize data in real time. For example, a financial report can pull live data from accounting software, ensuring that stakeholders always have access to the most current information. This capability eliminates the need for manual updates and reduces the risk of errors caused by outdated data.

### Lifecycle Management

Traditional electronic documents lack the ability to manage their lifecycle autonomously. Smart documents, on the other hand, can track their history, interactions, and versions, providing a comprehensive audit trail. For example, a healthcare record can log every access, update, and interaction, ensuring transparency and accountability. This lifecycle management is invaluable for industries that require strict compliance and traceability.

### Integration With Digital Ecosystems

Smart documents can seamlessly integrate into broader digital ecosystems, interacting with third-party applications, platforms, and systems. For instance, a marketing brochure can integrate with analytics platforms to track user engagement, dynamically update content based on preferences, and provide interactive features such as embedded videos or purchase options. This integration enhances workflows and unlocks new possibilities for automation and collaboration.

### Improved Efficiency

By automating repetitive tasks, smart documents reduce the burden on users and systems. For example, a smart invoice can automatically calculate late fees, track payment status, and send reminders to recipients. This automation not only saves time but also minimizes errors and ensures consistency across processes.

### Security

Embedded intelligence allows smart documents to enforce robust security measures, such as encryption, authentication, and access control. Unlike traditional documents, which rely on external systems for security, smart documents can protect themselves from unauthorized access and tampering. For instance, a government-issued permit can ensure that only authorized personnel can access sensitive information, even if the document is shared widely.

Having explored the numerous advantages of transitioning electronic documents to smart documents—such as dynamic interaction, granular access control, real-time data synchronization, lifecycle management, enhanced collaboration, and security—it becomes evident that this transformation is not merely a technological upgrade but a fundamental shift in how documents interact with their environment. The process of transforming traditional electronic documents into smart documents involves various methods that can ensure seamless integration into digital ecosystems while maintaining robust security and control. By replacing static files with intelligent entities linked to secure cloud locations or other networked locations, the transformation process offers flexible approaches tailored to organizational needs. Whether through system-wide sweeps, incremental transformation as documents are accessed, periodic transformation during off-hours, or transformation as documents are shared, the methods of transformation are as versatile as the capabilities of the smart documents themselves.

The systems and methods disclosed here can transform traditional electronic documents into self-determinative documents in any suitable manner that enables enhanced control, security, and/or management capabilities for the electronic documents. In one example, transformation can occur dynamically as legacy documents are accessed using a reader capable of displaying transformed documents. In this approach, the system checks whether a document has already been transformed, either by another user or in a different location, and links the newly accessed instance to the existing transformed version (e.g., via an entry page). In additional examples, targeted transformation of specific documents can be performed before sharing them with external parties, replacing conventional PDF readers with readers capable of displaying transformed documents as they are accessed. In other examples, transformation may be performed as a system-wide sweep to legacy documents during off-hours, similar to installing a software update. In one exemplary embodiment, a system-wide sweep is performed to transform all documents within an organization or those meeting specific criteria.

Alternative approaches to transformation include prioritizing specific groups, such as the C-Suite or department leaders, or working through the organization hierarchically, starting with individual contributors and progressing to higher management levels. Regardless of the method, the result can be a Master Data Record of the organization's documents, enabling centralized control and streamlined management. Once an organization's documents are transformed, the organization can gain the ability to exercise Total Document Control™ (TDC), unlocking various capabilities. TDC enables organizations to manage access to documents at granular levels, such as by department, position, deal, or other customizable criteria. This transformative approach to document management ensures enhanced security, streamlined workflows, and centralized control, addressing longstanding challenges in traditional document handling while enabling innovative applications across industries.

The transformation of electronic documents into smart documents with embedded intelligence represents a fundamental shift in how we perceive and utilize documents. No longer constrained by the static nature of the Gutenberg paradigm, smart documents redefine the role of documents in the digital age. They are dynamic, interactive, and intelligent entities that adapt to their environment, enhance workflows, and unlock new possibilities for integration and automation.

This new paradigm is not just an evolution of existing technology—it is a change that challenges the very foundation of document management. By embracing smart documents, we can move beyond the limitations of the past and create a future where documents are active participants in digital ecosystems, driving efficiency, collaboration, and innovation. The advantages are clear, and the potential is limitless. It is time to leave the Gutenberg paradigm behind and embrace the transformative power of smart documents.

As noted, aspects of this disclosure are directed to smart documents, which may also be referred to as self-determinative documents. Self-determination for a document is an advanced concept in document management, characterized by its ability to autonomously manage its lifecycle, access, and interactions through embedded intelligence. At the heart of a self-determinative document is the embedded intelligence, often implemented through a software chip, API, or any other suitable intelligence that allows the document to operate independently. This intelligence enables the document to execute tasks such as data retrieval, access control, and interaction management without external input. For example, a self-determinative document can autonomously update its content by fetching the latest data from a connected database, ensuring that users always have access to the most current information.

Self-determinative documents can also be equipped with sophisticated access control mechanisms that allow them to manage who can view, edit, or share their content. This includes role-based permissions, multi-factor authentication, and encryption. For instance, a legal document can restrict access to certain clauses based on the user's role, ensuring that only authorized personnel can view sensitive information. The document can also adapt to changes in user roles or security requirements, maintaining confidentiality, integrity, and availability.

Self-determinative documents may be capable of managing their own lifecycle, from creation to archiving. They can convert existing documents into self-determinative formats, perform deduplication to eliminate redundant copies, and manage version control to ensure data integrity. For example, a self-determinative document can automatically archive older versions while maintaining a single, up-to-date version accessible to users. Additionally, the document can execute a deconversion process, temporarily reverting to a previous state under specific conditions, providing flexibility in document management.

Self-determinative documents are designed to integrate seamlessly with existing systems and workflows. They can interact with other software applications, databases, and cloud services, facilitating automated workflows and data synchronization. For example, a project management document can automatically update task statuses based on inputs from team members, ensuring that all stakeholders have real-time visibility into project progress.

The ability to transform is integral to self-determinative documents, allowing them to be partially or instantly converted into smart digital objects. Partial transformation enables only certain elements of a document to be converted, while instant transformation allows for immediate conversion upon identification. For instance, a financial report can be partially transformed to include only the most critical data points, while a marketing document can be quickly transformed to ensure rapid dissemination of the latest campaign details.

A self-determinative document maintains a single source of truth within the network, eliminating the existence of multiple copies. This ensures consistent access and management, reducing redundancy and enhancing data reliability. For instance, a corporate policy document can be maintained as a single, authoritative version, ensuring that all employees access the same information.

As discussed in greater detail herein, a self-determinative document is a sophisticated, autonomous entity that leverages embedded intelligence to manage its own access, interactions, and lifecycle. It offers enhanced security, integration, and flexibility, addressing the limitations of traditional document management systems and providing a robust solution for modern digital environments. The examples provided in this disclosure illustrate the wide-ranging potential applications and benefits of self-determinative documents across various industries and use cases.

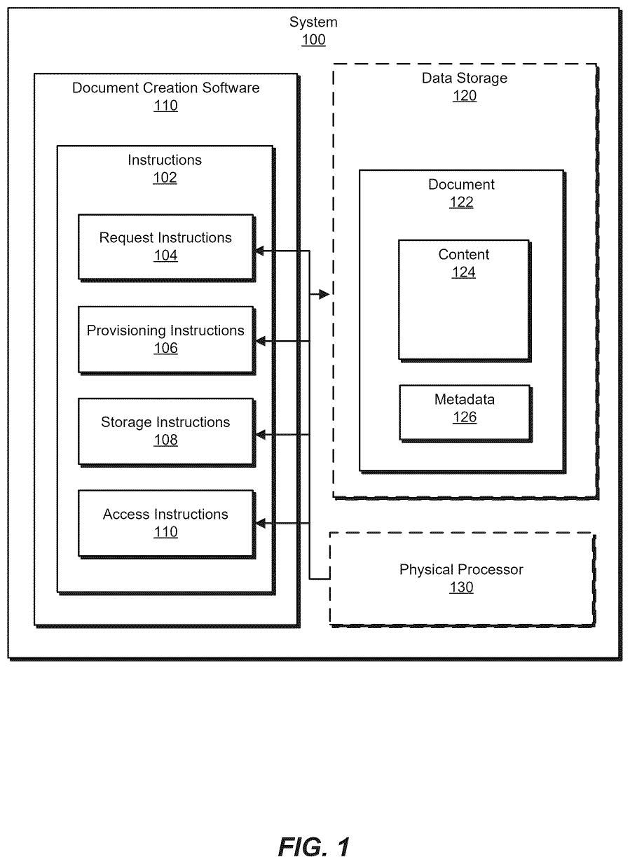

FIG. 1 shows a System 100 designed for managing electronic documents as smart digital objects. The System 100 includes a Document creation software 140, Instructions 102, Data Storage 120, Document 122, and a Physical Processor 130. The Instructions 102 include Request Instructions 104, Provisioning Instructions 106, Storage Instructions 108, and Access Instructions 110, all of which facilitate various interactions within self-determinative documents.

The Document creation software 140 is responsible for initiating the creation of documents that are capable of self-management within the System 100. The Document Creation Software 140 includes the Instructions 102 to manage document creation requests and provisioning processes. In this aspect, the Document Creation Software 140 serves as a central hub for document management operations, ensuring seamless integration and communication between different components of the System 100. In other aspects, the Document Creation Software 140 can be a distributed document creation system.

The Instructions 102 offer specialized functionality for document management. The Request Instructions 104 manage incoming requests for document creation and conversion, enabling users to initiate processes within the System 100. The Provisioning Instructions 106 are responsible for embedding intelligence into documents, enabling them to make autonomous decisions. The Storage Instructions 108 oversee the storage of data, ensuring data integrity and accessibility. The Access Instructions 110 support secure access to documents, implementing access control measures to protect sensitive information.

The Data Storage 120 is responsible for storing self-governing documents, such as document 122. The Data Storage 120 ensures that all data is securely maintained and readily accessible for authorized users. The Document 122 represents the information contained within the documents, which can be dynamically updated and managed through the embedded intelligence. While shown as part of a single system 100 in FIG. 1, the Data Storage 120 can be distributed across a network.

The data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

The Physical Processor 130 serves as the computational engine of the System 100, executing the embedded intelligence and managing document operations. This component processes requests, provisions documents, and facilitates access to Document 122, providing efficient and secure document management. The Physical Processor 130 operates in conjunction with the Instructions 102 and Data Storage 120 to provide a robust and reliable system for managing electronic documents.

In some examples, system 100 generally represents a document migration system or service. The migration service plays a role in transitioning legacy documents into the factified document ecosystem while maintaining compatibility with existing workflows and systems. It ensures seamless adoption of factified documents across industries and organizations by addressing key challenges related to backward compatibility, deduplication, integration, and automation.

The migration service can create entry pages associated with the document, which act as a bridge between legacy systems and the factified document ecosystem. In some examples, an entry page can be a wrapper that looks like a legacy document but functions as a portal to a factified document. The migration system creates the entry page in a legacy format, such as a PDF, and is designed to be compatible with legacy systems and workflows. When opened in a legacy document reader, the entry page provides instructions or a call-to-action that directs the user to access the factified document through the factified document reader.

This dual-use functionality allows the entry page to serve two purposes: (1) it acts as a readable document in legacy systems, ensuring backward compatibility, and (2) it serves as a gateway to the enhanced capabilities of the factified document ecosystem. The entry page bridges the gap between legacy systems and the factified document ecosystem, enabling organizations to transition seamlessly without disrupting existing workflows.

Additionally, the entry page can be used to maintain compatibility with external parties, such as government agencies or regulators, who may not yet support factified documents. It ensures that the factified document can be accessed and utilized even in environments that rely on legacy formats.

The migration service also addresses the handling of incoming legacy documents. For example, when a legacy document is received via email or uploaded to a portal, the service can automatically factify the document upon arrival. This includes deduplication to match the incoming document to its original factified version, preventing the creation of duplicates. This capability is particularly useful in workflows involving external parties, such as government agencies or regulators, who may not yet support factified documents. Another key feature is the ability to “resurrect” documents that have been degraded into legacy formats for external use and later returned to the system. The migration service identifies the origin of the returned document and reintegrates it into the factified ecosystem by matching visible or invisible identifiers, such as QR codes or metadata. This process ensures that the returned document is recognized as the same document originally sent out, maintaining the integrity of the system of record and preventing the proliferation of duplicates.

The migration service supports integration with various systems, including email clients, customer portals, and fax machines. For example, it can integrate with email servers or clients to automatically factify incoming attachments. Similarly, it can process documents uploaded through customer portals or received via fax, ensuring that all incoming documents are converted into factified documents and properly categorized within the system of record.

Designed to handle a wide range of legacy formats, including PDFs, scanned images, and other digital file types, the migration service enables organizations to transition their entire corpus of documents into the factified ecosystem without losing critical information. Specific use cases illustrate its utility across industries. For instance, in the pharmaceutical industry, marketing materials submitted to the FDA in legacy formats can be factified upon return, preserving the original factified document as the single source of truth. In the automotive industry, loan applications filled out by customers and returned as hard copies can be scanned and reintegrated into the factified system, maintaining their connection to the original document.

The migration service leverages automation and AI to streamline the process of factifying legacy documents. This includes intelligent deduplication, metadata extraction, and content recognition to ensure that incoming documents are accurately processed and integrated into the system of record. These capabilities are essential for scaling the adoption of factified documents across large organizations with diverse workflows.

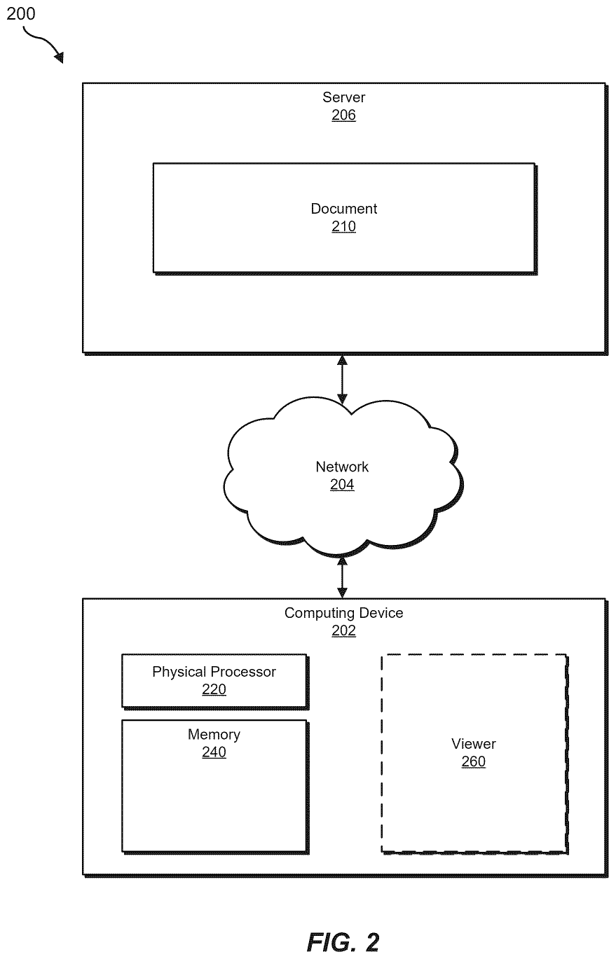

FIG. 2 shows a system 200 for managing electronic documents as smart digital objects. The system 200 includes a Server 206, the Document 210, a Network 204, a Computing Device 202, a Physical Processor 220, a Memory 240, and a Viewer 260. The Server 206 hosts the Document 210, which is accessible through the Network 204. The Computing Device 202, equipped with the Physical Processor 220 and Memory 240, interacts with the Document 210 via the Network 204, utilizing the Viewer 260 for document visualization and interaction.

The Server 206 is responsible for storing and managing the Document 210, ensuring the availability and integrity of the Document 210. The Document 210, hosted within the Server 206, is designed to operate as a smart digital object, capable of self-management and interaction with other components of the System 200. The Server 206 facilitates the access and interaction of the Document 210 with external entities such as the Computing Device 202 through the Network 204.

The Network 204 serves as the communication medium between the Server 206 and the Computing Device 202. This network enables the transfer of data and requests, allowing the Computing Device 202 to access and interact with the Document 210. The Network 204 ensures secure and efficient communication, supporting the operations of the System 200.

The Computing Device 202 is equipped with a Physical Processor 220 and Memory 240 for storing data and executing tasks related to document management. The Physical Processor 220 processes requests and operations, while the Memory 240 stores data and instructions needed for the Computing Device 202's functionality. Together, they enable the Computing Device 202 to interact with the Document 210 and perform various document management tasks.

As noted, the Viewer 260 is a component of the Computing Device 202 that provides a user interface for visualizing and interacting with the Document 210. This component allows users to view, edit, and manage the Document 210, facilitating seamless interaction and control. The Viewer 260 enhances the user experience by providing intuitive access to the features and functionalities of the Document 210.

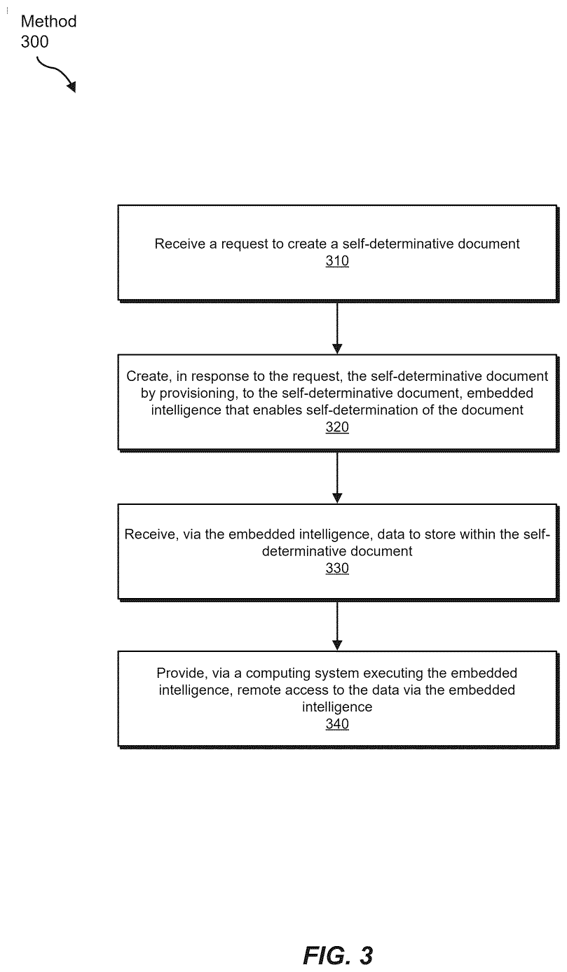

Turning to FIG. 3, the following provides a detailed description of a method for creating and managing a document with embedded intelligence. FIG. 3 illustrates the step-by-step process involved in creating a self-determinative document or transforming a traditional document into a self-determinative entity, capable of autonomous decision-making and interaction. By embedding intelligence within the document, the method enables dynamic content management, secure access control, and real-time updates, enabling the document to operate independently within a digital ecosystem.

Step 310 in FIG. 3 involves receiving a request to create a self-determinative document, which is the initiation of the document's creation as a smart digital object or transformation into a smart digital object. In some aspects, the process begins when a user or system submits a request to create a self-determinative document. This request can originate from various sources, such as a user interface, an automated system, or an integrated application. The request typically includes parameters that define the document's intended purpose, format, and any specific functionalities required. For example, the request may specify whether the document should be a PDF, Word, or Excel file, and whether it should include features like real-time data updates or advanced access controls.

Some examples involve three primary methods for transforming traditional documents into intelligent, self-governing digital objects. These methods address different stages of document creation, receipt, and manual conversion, ensuring flexibility and adaptability across various workflows.

At Birth: The first method involves creating intelligent digital objects directly from applications such as Word, Excel, or Canva. Instead of exporting a document to a static format like PDF, this method integrates the transformation process into the document creation workflow itself. By embedding intelligence at the moment of creation, the document is immediately equipped with capabilities such as self-governance, dynamic interaction, and secure access control. This approach eliminates the need for subsequent conversion steps and ensures that the document is ready for advanced functionality from the outset.

On Arrival: The second method focuses on incoming documents, such as email attachments or files downloaded from the web. Upon receipt, these documents are automatically transformed into intelligent digital objects. This process ensures that all documents entering an organization are converted into a format that supports enhanced security, lifecycle management, and interaction capabilities. For example, an email attachment containing a scanned contract can be immediately transformed into a secure, interactive digital object, enabling streamlined workflows and reducing the risk of data breaches.

On Demand: The third method allows users to manually transform specific documents through a centralized hub or workspace. This approach is particularly useful for legacy files or documents that require advanced capabilities for specific use cases. Users can select individual documents and initiate the transformation process, adding features such as embedded intelligence, secure access control, and dynamic interaction. This method provides flexibility for organizations that need to selectively upgrade their document management systems while maintaining compatibility with existing workflows.

Each of these methods addresses distinct scenarios in document handling, ensuring that organizations can seamlessly transition to advanced digital document ecosystems while preserving operational efficiency and security. Any other suitable method for converting digital documents can also be used.

In some examples, documents are transformed from their editable state into smart documents when their content is finalized and ready to become immutable. This transformation process involves embedding intelligence into the document, securing its content through cryptographic techniques, and provisioning it with features that enable self-determination, traceability, and secure interaction. The transition from an editable state to a smart document ensures that the document's content is preserved in its final form, while enabling advanced functionalities that enhance its usability, security, and integration into workflows.

The transformation begins when a user determines that the document's content is complete and no further edits are required. At this point, the document is provisioned with embedded intelligence, which includes executable code, metadata, and machine-readable content. This intelligence allows the document to manage its lifecycle autonomously, enforce access controls, track interactions, and adapt to changing contexts. The content is cryptographically secured, ensuring that it remains immutable and trustworthy throughout its lifecycle. The document is also assigned a permanent global marker, which serves as its unique identifier and links its content and audit trail

In one example, a legal contract created in a word processing application is transformed into a smart document once all parties have agreed on the terms. The document's content is hashed to produce a cryptographic fingerprint, and the hash is stored alongside the document to verify its integrity. The document is digitally signed by the authorized parties, ensuring its authenticity and finality.

In another example, a financial report prepared in a spreadsheet application is transformed into a smart document when the data is finalized and approved by the finance team. The document is provisioned with embedded intelligence that allows it to synchronize with external systems, such as accounting software, and provide real-time updates to stakeholders.

In another example, a marketing brochure designed in a graphic design application is transformed into a smart document when the layout and content are finalized for distribution. The document is secured with cryptographic techniques and provisioned with features that allow it to track user engagement, such as heatmaps and click-through rates.

In another example, a project plan created in a collaborative planning tool is transformed into a smart document when the team agrees on the timeline and deliverables. The document is provisioned with embedded intelligence that enables it to track progress, notify stakeholders of pending tasks, and update timelines based on real-time inputs.

In another example, a research paper written in a word processing application is transformed into a smart document when the author submits it for publication. The document is secured with cryptographic techniques and provisioned with features that allow it to track citations, downloads, and interactions.

In another example, a product specification document created in a technical writing tool is transformed into a smart document when the engineering team finalizes the design. The document is provisioned with embedded intelligence that allows it to integrate with project management tools and track changes to the design.

In another example, a training manual prepared in a word processing application is transformed into a smart document when the content is finalized for distribution to employees. The document is secured with cryptographic techniques and provisioned with features that allow it to track user interactions, such as completion rates and feedback.

In another example, a policy document created in a word processing application is transformed into a smart document when the organization's leadership approves the content. The document is provisioned with embedded intelligence that allows it to enforce access controls and track compliance.

In another example, a sales proposal prepared in a presentation tool is transformed into a smart document when the sales team finalizes the offer. The document is secured with cryptographic techniques and provisioned with features that allow it to track client interactions and approvals.

In another example, a curriculum designed in an educational planning tool is transformed into a smart document when the school administration approves the content. The document is provisioned with embedded intelligence that allows it to track student progress and adapt to individual learning needs.

In another example, a user manual created in a technical writing tool is transformed into a smart document when the product team finalizes the instructions. The document is secured with cryptographic techniques and provisioned with features that allow it to track user interactions and provide real-time updates.

In another example, a business plan prepared in a word processing application is transformed into a smart document when the executive team approves the strategy. The document is provisioned with embedded intelligence that allows it to track progress and adapt to changing market conditions.

In another example, a grant proposal written in a word processing application is transformed into a smart document when the research team submits it for funding. The document is secured with cryptographic techniques and provisioned with features that allow it to track interactions with funding agencies.

In another example, a compliance report prepared in a spreadsheet application is transformed into a smart document when the regulatory team finalizes the data. The document is provisioned with embedded intelligence that allows it to enforce access controls and track compliance.

In another example, a customer service guide created in a word processing application is transformed into a smart document when the content is finalized for distribution to support teams. The document is secured with cryptographic techniques and provisioned with features that allow it to track user interactions and provide real-time updates.

In another example, a product roadmap designed in a collaborative planning tool is transformed into a smart document when the team agrees on the timeline and milestones. The document is provisioned with embedded intelligence that enables it to track progress and adapt to changing priorities.

In another example, a press release written in a word processing application is transformed into a smart document when the communications team finalizes the content for distribution. The document is secured with cryptographic techniques and provisioned with features that allow it to track media interactions and engagement.

In another example, a safety protocol document created in a technical writing tool is transformed into a smart document when the organization's leadership approves the procedures. The document is provisioned with embedded intelligence that allows it to enforce access controls and track compliance.

In another example, a strategic plan prepared in a word processing application is transformed into a smart document when the executive team finalizes the goals and objectives. The document is provisioned with embedded intelligence that allows it to track progress and adapt to changing conditions.

In another example, a vendor agreement created in a word processing application is transformed into a smart document when all parties sign the contract. The document is secured with cryptographic techniques and provisioned with features that allow it to track interactions and enforce access controls.

These examples illustrate how documents are transformed from their editable state into smart documents when their content is finalized and ready to become immutable. This transformation process ensures that the document's content is preserved in its final form while enabling advanced functionalities that enhance its usability, security, and integration into workflows. By embedding intelligence, securing content, and provisioning features, smart documents redefine the role of digital documents in modern systems.

A discovery service can be particularly useful for managing and transforming legacy documents into intelligent, interactive digital objects. The discovery service operates by scanning repositories, databases, or storage systems to locate documents, files, or data that meet specific criteria. Once identified, the service can analyze the content, metadata, and structure of these assets to determine their relevance, relationships, and potential for integration into a more advanced digital ecosystem.

For example, in an enterprise setting, a discovery service might scan a file management system to locate all documents related to a specific project or department. It could identify duplicates, outdated versions, or incomplete files, and then consolidate the information into a single authoritative record. The service could also assess the security and access permissions associated with each document, ensuring compliance with organizational policies and regulatory requirements. By automating these processes, the discovery service reduces manual effort, enhances data integrity, and prepares the documents for transformation into a more dynamic and secure format.

Additionally, the discovery service can integrate with other IT systems, such as customer relationship management (CRM) platforms or enterprise resource planning (ERP) systems, to provide a holistic view of the organization's digital assets. This integration enables seamless workflows, real-time updates, and improved collaboration across departments. The discovery service acts as a foundational tool for organizations seeking to modernize their document management practices, ensuring that all digital assets are accounted for, organized, and ready for advanced functionalities.

Returning to FIG. 3, upon receiving the request, the system initiates the provisioning of the document by embedding intelligence within it (step 320). This intelligence may be implemented through an embedded software chip or API, which provides the document with the ability to execute tasks autonomously. The embedded intelligence allows the document to perform operations such as data retrieval, access control, and interaction management without external input. This capability transforms the document into a self-governing entity that can adapt to changing conditions and user requirements.

During this step, the system may also configure the document's access control settings, defining who can view, edit, or share the document. This involves setting up role-based permissions, multi-factor authentication, and encryption protocols to ensure that only authorized users can interact with the document. These security measures maintain the document's confidentiality, integrity, and availability.

In some aspects, embedding intelligence within a document involves integrating advanced functionalities that transform the document from a static file into a dynamic, interactive entity capable of executing operations independently. One method of embedding intelligence is through an Application Programming Interface (API), which serves as a conduit for interaction between the document and external systems, applications, and users. The API provides a standardized set of protocols and tools that define how software components should interact with the document, allowing it to perform tasks such as data retrieval, access control, and real-time updates autonomously. For example, the API can enable the document to fetch the latest data from a connected database whenever it is accessed, ensuring that users always have access to the most current information.

Additionally, intelligence can be embedded through software chips, which are small programs integrated into the document to execute specific tasks like monitoring user interactions, enforcing access permissions, and logging changes. In some aspects, the software chips comprise APIs. Machine learning algorithms can also be embedded, allowing the document to analyze data patterns and make informed decisions based on historical interactions, such as predicting user behavior and adjusting access permissions accordingly. Metadata and tags provide contextual information about the document's content and usage, automating processes like version control, deduplication, and lifecycle management. Furthermore, embedding encryption and authentication protocols enhances the document's security by ensuring that only authorized users can access and modify its content. By embedding intelligence through these and/or any other suitable methods, a document can operate as a self-governing entity, capable of managing its own interactions and lifecycle without external intervention, thus providing a robust solution for modern document management challenges and enhancing security, integration, and flexibility.

For example, consider the creation of a self-determinative financial report. Upon receiving a request to create this document, the system embeds intelligence that allows the report to automatically update its data by connecting to a financial database. This ensures that users always have access to the most current financial information. Additionally, the document can be configured to restrict access to sensitive sections based on user roles, ensuring that only authorized personnel can view or edit specific data.

Another example is the creation of a self-determinative legal contract. The system can embed intelligence that enables the contract to enforce access permissions based on predefined criteria, such as the user's role or security clearance. The document can also be programmed to track changes and maintain a version history, providing a comprehensive record of all modifications made to the contract.

During the creation process, the system may also configure the document's access control settings, defining who can view, edit, or share the document. This involves setting up role-based permissions, multi-factor authentication, and encryption protocols to ensure that only authorized users can interact with the document. These security measures enable maintaining the document's confidentiality, integrity, and availability.

The creation of a self-determinative document can involve one or more processes that ensure the document is immutable, establish it as the one true copy, and imbues it with its unique characteristics. Below is a detailed explanation of each aspect:

### 1. Making the Data Immutable

Immutability refers to the property of the document's content being unchangeable once it is finalized. This is part of ensuring the integrity and trustworthiness of the document. The process of making the data immutable can involve one or more of the following steps:

### a. Cryptographic Hashing

A cryptographic hash is generated for the document's content. This hash acts as a unique fingerprint for the document. Any alteration to the content, even a single character, would result in a completely different hash value. This ensures that the content cannot be tampered with without detection.

### b. Digital Signatures

The document is digitally signed using the private key of the document's owner or creator. This signature is attached to the document and can be verified using the corresponding public key. The digital signature guarantees that the document originated from the owner and has not been altered since it was signed.

### c. Version Control

The system ensures that any changes to the document result in the creation of a new version, rather than altering the original content. Each version is independently hashed and signed, preserving the immutability of prior versions.

### d. Storage in Secure Systems

The document is stored in a secure, tamper-proof system. By implementing these measures, the document's content becomes immutable, ensuring its integrity and reliability.

### 2. Establishing the Document as the One True Copy

The concept of the “one true copy” ensures that there is a single authoritative version of the document, eliminating redundancy and confusion caused by multiple copies. This is achieved through the following mechanisms:

### a. Unique Global Identifier

The document is assigned a unique global marker or identifier, such as a permanent URL. This identifier is immutable and always points to the authoritative version of the document.

### b. Centralized or Distributed Storage

The document is stored in a centralized or distributed system that guarantees its availability and authenticity. Any access to the document is directed to this authoritative version, ensuring that users interact with the one true copy.

### c. Deduplication

When the document is shared or transmitted, the system performs deduplication to ensure that any incoming or outgoing copies are linked back to the original authoritative version. For example, if a printed version of the document is scanned and uploaded, the system recognizes it as a derivative of the original and links it accordingly.

### d. Entry Pages for Legacy Systems

For compatibility with legacy systems, the document may include an entry page or wrapper that directs users to the authoritative version. This ensures that even when interacting with older systems, users are ultimately accessing the one true copy. By establishing the document as the one true copy, the system eliminates the proliferation of duplicate or conflicting versions, ensuring consistency and trust.

### 3. Imbuing the Document With its Unique Characteristics

A self-determinative document is not merely a static file; it is an intelligent entity capable of governing its own lifecycle, interactions, and access. This is achieved through the following features:

### a. Embedded Intelligence

The document is provisioned with embedded intelligence, typically implemented through an API or software chip. This intelligence enables the document to:

Respond to queries and requests.

Enforce access controls based on user roles and permissions.

Track interactions and maintain an audit trail.

### b. Metadata

The document includes structured metadata that provides contextual information about its content, provenance, and lifecycle. Metadata can include timestamps, user interactions, version history, and more. This allows the document to dynamically adapt to its environment and provide real-time insights.

### c. Lifecycle Management

The document autonomously manages its lifecycle, including creation, updates, archiving, and deletion. For example, the document can automatically archive older versions while maintaining a single authoritative version.

### d. Integration With Digital Ecosystems

The document can interact with external systems, such as databases, analytics platforms, and collaborative tools. This integration enhances its functionality and allows it to participate in broader workflows.

By incorporating these characteristics, the document becomes a dynamic, intelligent entity that transcends the limitations of traditional static files.

The creation of a self-determinative document involves transforming it into an immutable, authoritative, and intelligent entity. Immutability ensures the integrity of the content, the “one true copy” concept eliminates redundancy and confusion, and embedded intelligence imbues the document with unique capabilities. Together, these features redefine the role of documents in the digital age, enabling secure, efficient, and dynamic interactions across platforms and ecosystems.

Traditionally, PDFs have been the go-to format for creating static, shareable documents that preserve formatting across devices and platforms. However, PDFs are inherently limited by their static nature, lack of interactivity, and inability to adapt dynamically to changing contexts or user needs. Self-determinative documents, on the other hand, offer an alternative by embedding intelligence, interactivity, and self-governance into the document itself.

Self-determinative documents are designed to replace PDFs in any scenario where a static document would traditionally be created. Whether it's a contract, report, invoice, or form, the process of creating a Factified document is as straightforward as generating a PDF. The difference lies in the capabilities of the resulting document:

Static PDF: A fixed layout document that cannot adapt or interact.

Self-Determinative Document: A dynamic, intelligent entity capable of self-governance, interactivity, and integration with digital ecosystems.

### 2. Enhanced Functionality

Self-determinative documents retain all the benefits of PDFs, such as preserving formatting and being shareable across platforms, while introducing advanced features that PDFs cannot offer:

Interactivity: Factified documents can respond to user actions, queries, and requests, enabling real-time collaboration and updates.

Granular Access Control: Permissions can be enforced at the content level, allowing different users to access specific sections based on their roles.

Lifecycle Management: Factified documents autonomously track their history, interactions, and versions, providing a comprehensive audit trail.

Integration: These documents can seamlessly integrate with external systems, such as databases, analytics platforms, and collaborative tools.

### 3. Universal Applicability

The ability to create self-determinative documents extends to any scenario where a PDF would traditionally be used. Examples include:

Contracts: Self-determinative contracts can enforce terms, track compliance, and update stakeholders automatically.

Reports: Self-determinative reports can pull live data from connected systems, ensuring stakeholders always have access to the most current information.

Forms: Self-determinative forms can dynamically adapt to user inputs, validate data, and integrate with backend systems for processing.

Invoices: Self-determinative invoices can calculate late fees, track payment status, and send reminders autonomously.

### 4. Backward Compatibility

Self-determinative documents are designed to be backward compatible with legacy systems that rely on PDFs. For example, a Factified document can include an entry page or wrapper that functions as a traditional PDF when opened in legacy readers. This ensures that organizations can transition to Factified documents without disrupting existing workflows.

### 5. Future-Proofing Document Management

By creating self-determinative documents instead of creating PDFs, organizations can future-proof their document management practices. Self-determinative documents are built to adapt to evolving technologies, integrate with AI systems, and support advanced workflows, making them a robust solution for modern digital environments.

### 6. Machine Readability

Self-determinative documents are inherently machine-readable, designed to interact seamlessly with computational systems and applications. Unlike traditional documents that primarily serve human-readable purposes, self-determinative documents encode their content, metadata, and audit trails in structured, machine-readable formats such as JSON, XML, or other standardized data representations. This structure allows external systems, such as artificial intelligence agents, APIs, or enterprise software, to query, analyze, and interact with the document programmatically. Embedded intelligence within the document further enhances machine readability by enabling dynamic responses to requests, such as retrieving specific data, verifying authenticity, or executing workflows. By being machine-readable, self-determinative documents facilitate automation, integration, and advanced computational interactions, making them a foundational element for modern digital ecosystems.

Self-determinative documents are not just an alternative to PDFs—they are a superior evolution. They retain the simplicity and universality of PDFs while unlocking new possibilities for interactivity, security, and integration. By creating self-determinative documents, organizations can move beyond the limitations of static files and embrace a new era of intelligent, dynamic, and self-governing digital documents.

Step 330 in FIG. 3 involves receiving, via the embedded intelligence, data to store within the self-determinative document. This data can originate from external databases, user inputs, or automated systems. The embedded intelligence within the document processes the incoming data. This capability allows the document to maintain a single source of truth, eliminating redundancy and ensuring data integrity.

For example, consider a self-determinative project management document. As team members update task statuses or add new information, the document receives this data through its embedded intelligence. The document can then automatically adjust timelines, update progress indicators, and notify relevant stakeholders of changes, enabling all users to have access to the most current project information.

Another example is a self-determinative inventory management document. As inventory levels change, the document receives data from connected systems, such as point-of-sale terminals or warehouse management systems. The embedded intelligence processes this data, updating stock levels and generating alerts for low inventory, ensuring that the document reflects real-time inventory status.

During this step, the document may also perform data validation checks, ensuring that the received data meets predefined criteria for accuracy and completeness. This process maintains the document's reliability and ensures that users can trust the information it provides. In some examples, step 330 may be performed before or simultaneous with step 320.

Step 340 in FIG. 3 involves providing, via a computing system executing the embedded intelligence, remote access to the data within the self-determinative document. This step enables users to interact with the document's content securely and efficiently, regardless of their location or device. The embedded intelligence facilitates this remote access, making the document's data accessible to authorized users while maintaining security and control.

The process of step 340 begins with the computing system executing the embedded intelligence within the document, which manages access requests and permissions. This system can authenticate users, verify their credentials, and determine their access rights based on predefined criteria such as roles, security clearances, or organizational policies. By doing so, the system ensures that only authorized users can access the document's data, protecting sensitive information from unauthorized access.

For example, consider a self-determinative legal document that requires remote access by multiple stakeholders. The embedded intelligence can enforce access permissions based on user roles, allowing legal advisors to view and edit specific sections while restricting access for other parties. This ensures that the document's confidentiality and integrity are maintained, even when accessed remotely.

Another example is a self-determinative financial report that needs to be accessed by remote auditors. The embedded intelligence can provide secure access to the report's data, allowing auditors to review financial information without compromising security. The system can also track access attempts and interactions, providing an audit trail for compliance purposes.

During this step, the computing system may also implement encryption protocols to protect the document's data during transmission, ensuring that it remains secure even when accessed over public networks. Additionally, the system can provide real-time updates and notifications to users, keeping them informed of changes or interactions with the document.

The transformation of existing documents into self-determinative documents involves a process where traditional files, such as PDFs, WORD documents, or EXCEL spreadsheets, are converted into intelligent, autonomous entities. This conversion is initiated by a request, which can be made by a user or an automated system, specifying the document to be transformed and any additional functionalities required. Embedded intelligence within the self-determinative document plays a role in this process, as it is responsible for copying the data from the existing document into the new format.

In some aspects, the conversion process can begin when a user completes a document in a native application like Microsoft Word, Excel, or PowerPoint. Instead of opting to print to PDF, the user may be presented with the option to “Publish to Transform.” By selecting this option, the user initiates the creation of a self-determinative document, which can involve storing data from the document in a secure cloud location and generating a cover page on the user's drive.

For example, a company may need to convert its quarterly financial reports, originally created in Excel, into self-determinative documents. The embedded intelligence within the new format copies the financial data, formulas, and charts, allowing the report to autonomously update its data by connecting to real-time financial databases. This ensures that stakeholders always have access to the most current information. Similarly, in a legal setting, a law firm might convert existing contracts stored as Word documents into self-determinative documents. The embedded intelligence enables the document to enforce access permissions based on user roles, ensuring that only authorized personnel can view or edit specific sections. Additionally, the document can track changes and maintain a version history, providing a comprehensive record of all modifications.

In project management, teams might have existing project plans in PDF format that need to be converted into self-determinative documents. The embedded intelligence allows the document to automatically update task statuses based on inputs from team members, facilitating real-time collaboration and ensuring that all stakeholders have visibility into project progress. This transformation process highlights the flexibility and adaptability of self-determinative documents, demonstrating how existing documents can be converted into intelligent entities capable of managing their own content and interactions, thus addressing the limitations of traditional document formats and providing a robust solution for modern document management challenges.

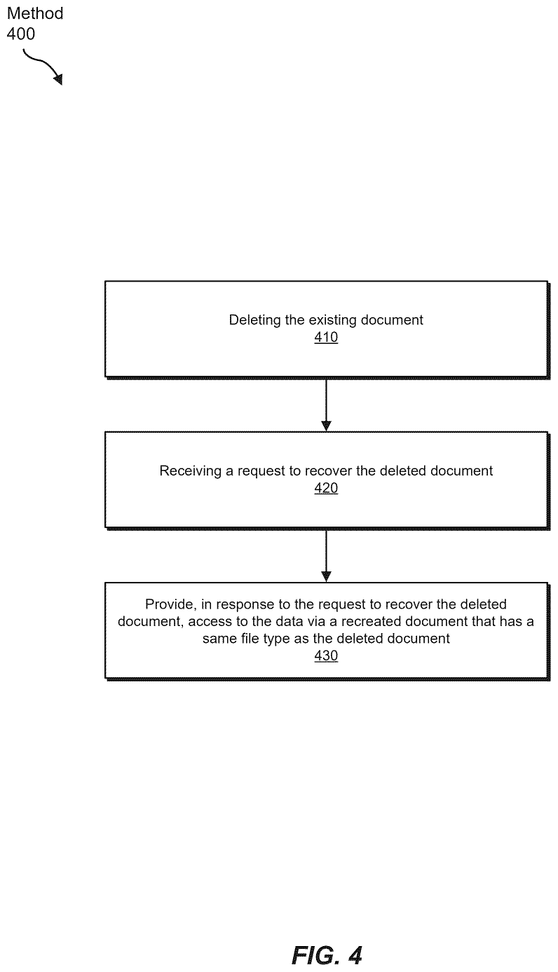

The method 400 in FIG. 4 is a process designed to allow reversion of a self-determinative document back to an original format after the document has been deleted (step 410) after being converted to a self-determinative document. At some point after deletion of the existing document, a request to recover the deleted document may be received (step 420). This step is initiated when a user or system identifies the need to restore access to a previously deleted document. The request to recover the document serves as a trigger for the subsequent steps in the recovery process, ensuring that the document can be retrieved and made accessible once again.

In response to the request to recover the deleted document, access to the data of the original document may be provided via a recreated document that has the same file type as the deleted document (step 430). In some aspects, this step involves the reconstruction of the deleted document from the data and other information in the self-determinative document. This process of recreation may be performed by the self-determinative document or by a system associated with the self-determinative document.

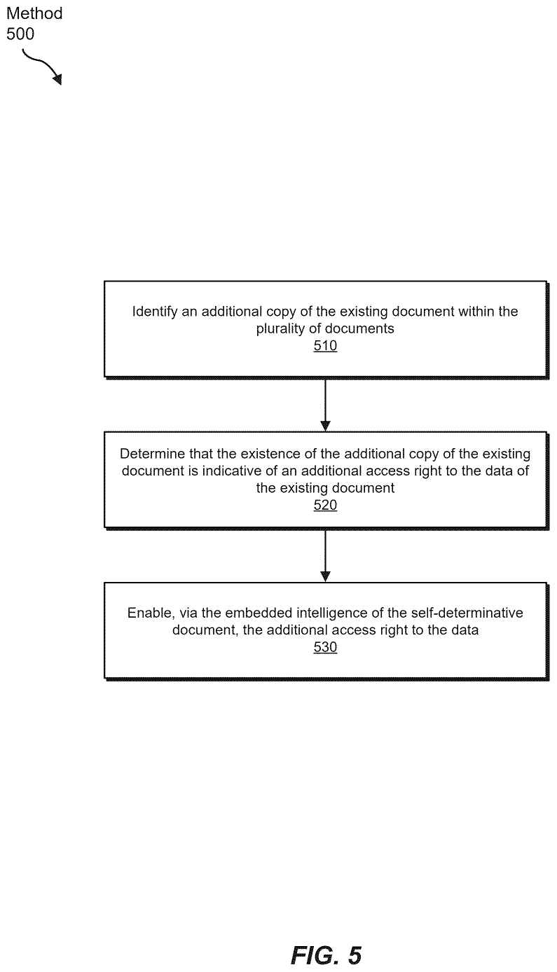

The method 500 in FIG. 5 is a process for identifying additional copies of existing documents and managing access rights when ensuring that there is only a single true copy of the document. Method 500 involves identifying an additional copy of an existing document that has been converted to a self-determinative document within the plurality of documents (step 510). This step may involve identifying all instances of a document are within a file management system. In other aspects, step 510 may involve identifying any copy of the document that can be located, whether within a file management system, within a network, or elsewhere. The identification process can be automated, utilizing algorithms to scan and compare document metadata, content, or specific identifiers to detect duplicates. This process may enable maintaining a single source of truth for stored data and may also reduce redundancy and ensure data integrity.

Once an additional copy of the existing document is identified, the method proceeds to determine that the existence of the additional copy of the existing document is indicative of an additional access right to the data of the existing document (step 520). For example, the system may determine that a user who does not have access rights to the original, existing document may have access rights to the additional copy of the document. This step is important for ensuring that all stakeholders with a legitimate interest in the document can access the document.

The method 500 also involves enabling, via the embedded intelligence of the self-governing document, the additional access right to the data (step 530). This step leverages the embedded intelligence within the document to autonomously manage access permissions. The embedded intelligence can dynamically adjust access controls based on the identified additional access rights, ensuring that authorized users can interact with the document as needed. This capability enhances the document's self-governance, allowing adaptation to changing access requirements without manual intervention. By enabling additional access rights through embedded intelligence, the system provides a flexible and secure approach to document management, accommodating the diverse needs of legitimate users while safeguarding sensitive information.

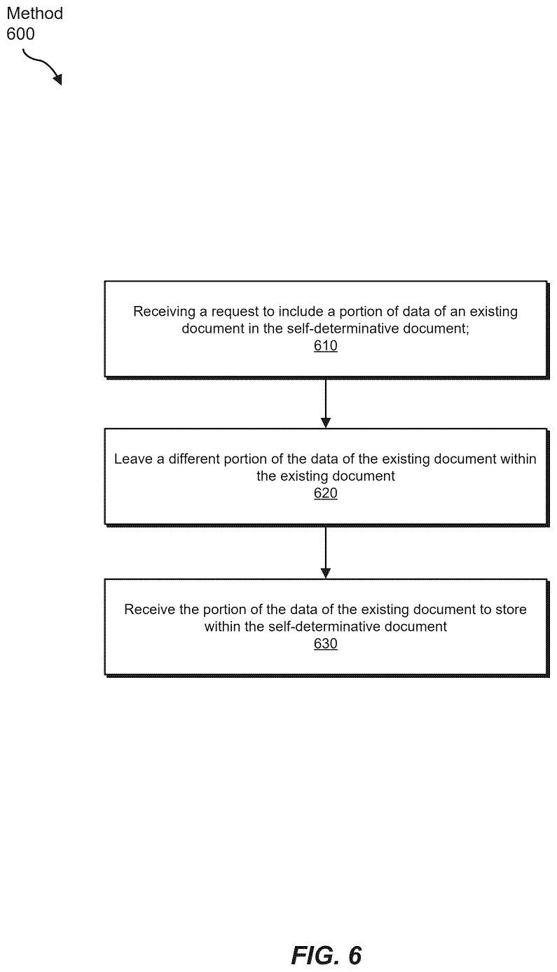

FIG. 6 explores the concept of partial transformation within the framework of self-determinative documents, illustrating how specific elements of a document or data within a document can be selectively endowed with autonomous capabilities. This approach enables organizations to integrate self-determinative features into their documents without necessitating a complete overhaul, providing a tailored solution to document management. Partial transformation is particularly useful for entities seeking to enhance certain functionalities, such as access control or data integrity, while maintaining other components in their original form. By focusing on the selective incorporation of data, FIG. 6 demonstrates how self-determinative documents can be customized to meet specific organizational needs, offering a strategic approach that balances control, security, and operational efficiency.

Converting a portion of a document or part of the data within a document into a self-determinative document involves selectively enhancing specific elements or data with embedded intelligence and autonomous capabilities. The process begins by identifying specific portions of the document or data that need transformation (step 610). These could be sensitive sections requiring enhanced access control, data points needing real-time updates, or interactive elements benefiting from autonomous management. Once identified, intelligence is embedded with these portions to create a self-determinative document.

The method also involves leaving a different portion of the data of the existing document within the existing document (step 620). The method also involves receiving the portion of the data of the existing document to store within the self-regulating document (step 630). This step involves the actual transfer and storage of the selected data portion within the self-regulating document, facilitated by the embedded intelligence within the document.

The concept of partial transformation offers an approach to document management that may allow documents to be converted into self-determinative entities earlier in their lifecycle. The transformation process may be applied to existing documents, such as PDFs stored locally, which were then converted into self-determinative documents upon opening with a specialized reader or viewer. This process may involve storing a copy of data of the document in a secure cloud location and replacing the original file with a cover page on a user's drive.

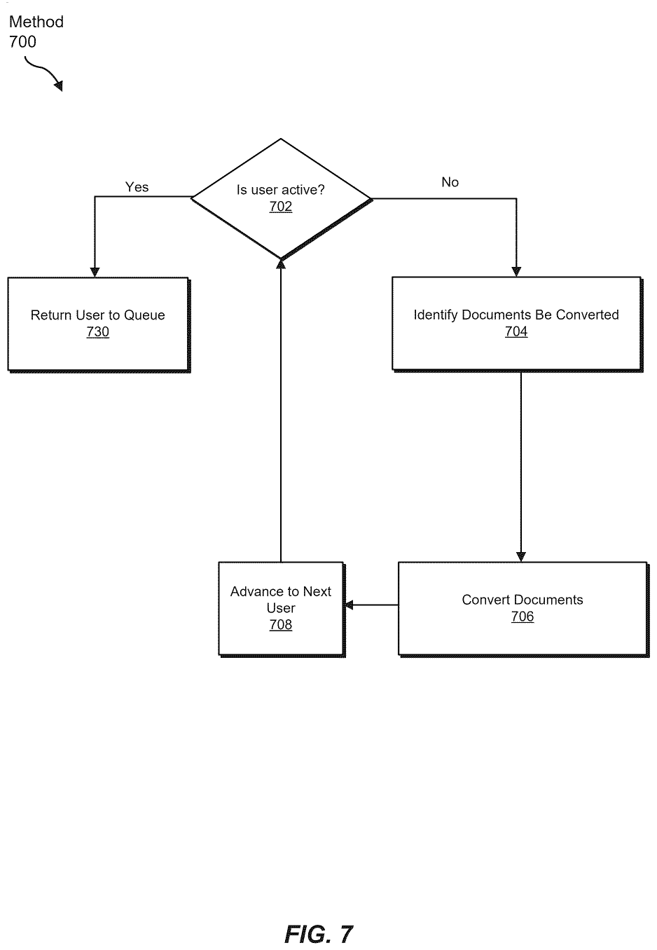

The method 700 in FIG. 7 is directed to managing conversion of existing documents into self-determinative documents within an entity having multiple users. The process begins with step 702, which involves assessing whether a user is active. This step may ensure that the conversion process does not interfere with the user's ongoing activities. The system checks the user's activity status by accessing records that indicate traditional patterns of use, conducting this step at a time when the system anticipates the user to be inactive. If the user is active, the system records this fact and moves on to another user, planning to revisit the initial user at a future time.

If the user is determined to be inactive, the method proceeds to step 704, which involves identifying documents to be converted. The criteria may include identifying all PDFs, documents with specific words or characters in their titles, or documents created before or after a particular date. Combinations of these criteria can also be utilized, such as identifying all documents with the word “Monkey” in the title created in the last two years. As a result of this step, a list of documents suitable for conversion is generated, setting the stage for the subsequent conversion process.

Once the documents 710 have been identified, the method advances to the conversion process, represented by step 740. This step involves transforming the identified documents 710 into self-determinative documents, as discussed herein.

After the conversion process is complete, the method advances to the next user, as indicated by step 740. This step involves repeating the same process for the next user, ensuring that all users'documents that meet the criteria are Factified. The process includes revisiting any users that were previously skipped due to their active status, ensuring comprehensive coverage of the organization's documents. This systematic approach ensures that all documents within the organization, or those that meet particular criteria, are converted into formats that allow for autonomous decision-making, enabling Total Document Control 750.

In one aspect, particular documents intended for sharing with a specific counterparty undergo conversion before being shared, enabling controlled access to those documents. In another aspect, PDF readers for all (or most) employees in the organization are replaced with viewers for self-determinative documents, and each time a PDF is subsequently accessed by one of the employees, the document undergoes conversion. In yet another instantiation, legacy documents undergo a conversion during a sweep operation conducted during off hours, akin to installing a software update to the system.

There are various ways to conduct a system-wide sweep and transform all documents within the organization, or those that meet particular criteria. For example, the system can first transform the documents of the C-Suite and leaders of the organization, then work through the organization on a department-by-department basis. Alternatively, the system can start with individual contributors and then transform documents of their managers, directors, and VPs. Regardless of the approach, the end result is that all documents meeting the criteria are transformed and comprise a Master Data Record of the company's documents.

Instead of the broad sweep operation, documents can be transformed as a result of being opened by a specialized reader. If an organization deploys these readers to all employees, then over time, the documents that matter most—those being accessed—will be transformed. When an employee opens a document, the system checks if it has already been transformed, either because another employee previously opened the same document or because the employee opened a copy stored in a different location. If the document has already been transformed, the system stores a link (e.g., a cover page) associated with the previously transformed copy at the location of the document being opened, linking it to the secure cloud location.

Once the company's documents have been transformed, either via the sweep approach, the as-you-go approach, or a combination thereof, the company can exercise more control, providing a wide array of capabilities. For example, with all documents being converted, the company can manage which individuals can access specific documents, whether on a department level, position level, deal level, or any other ad hoc approach the company wishes to deploy.

As described above, aspects of this disclosure cover concept of self-determinative documents, which can be digital documents designed to exist in a single instantiation and stored in a secure cloud location. Unlike traditional documents, self-determinative documents can eliminate unnecessary copies, such as those typically found in a sender's outbox or a receiver's inbox. Instead, these documents utilize gateways, links, or portals, such as cover pages, to point to the single copy stored in the cloud. This approach ensures that all interactions with the document are directed to the original, secure version, enhancing control and security.

Self-determinative documents can be both human-readable and machine-readable, equipped with an API that allows them to interact with machines via API calls. This capability enables the document to provide and receive data related to its provenance and timeline, making it particularly suitable for artificial intelligence applications. The API facilitates dynamic interaction, allowing users to query the document using conventional email systems, while the document responds with information that may not be readily apparent from simply reading it.

For instance, a self-determinative document can be addressed using a unique identifier, such as a sequence of hexadecimal characters, which ensures its uniqueness and provides a link to the single copy stored in the cloud. This identifier can be used to address the document for various interactions, such as reading or signing. Additionally, the document can be addressed via an email address, allowing users to send inquiries directly to the document and receive responses that leverage the document's embedded intelligence and AI capabilities.

Consider a scenario where a CEO needs information from a term sheet associated with a merger. In a traditional setting, the CEO would need to locate the term sheet and manually search for answers. However, with a self-determinative document, the CEO can send an email inquiry directly to the document, asking questions about signatures, purchase prices, or reviews. The document, utilizing its embedded intelligence, can provide detailed responses, including calculations and analytics, that would be difficult to obtain from a conventional document.

The document's ability to respond to inquiries extends beyond simple data retrieval. It can provide images associated with the signature process, overlay heat maps showing areas of attention, or present side-by-side renderings with analytics. These dynamic responses can update in real-time, reflecting ongoing interactions with the document.

Users can initiate interactions with self-determinative documents through native email systems or in-document applications. These applications can facilitate various processes, such as internal reviews, version control, and analytics, developed by the document's creators or third-party developers. The document can respond within these applications or through email, depending on the user's preferences.

The security of communications between users and self-determinative documents is important in many applications. For example, in some applications, only authorized users can view the questions and responses, even if emails are inadvertently forwarded. The document's embedded intelligence ensures that responses are tailored to the user's authority, providing full answers to those with appropriate permissions and partial answers to others.

Self-determinative documents also offer dynamic rendering capabilities, incorporating AI to tailor user experiences based on interactions and preferences. The system can recommend additional applications or features, allowing developers to rapidly create and deploy new functionalities based on user needs.

In summary, self-determinative documents represent a new paradigm in document management, offering enhanced control, security, and interaction capabilities. By leveraging embedded intelligence and cloud storage, these documents provide a robust solution for modern digital environments, transforming the way users access and interact with information.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker is established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will change document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that changes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In any example, a smart electronic document includes three elements, at minimum—data (e.g., content, audit trail, other metadata, etc.), executable code (e.g., an API), and a globally unique marker.

The method described in the claim leverages the foundational features of self-determinative documents to address technical problems inherent in traditional document systems. By embedding intelligence into the document, ensuring immutability, and enabling remote access, the method transforms the document into a dynamic, interactive entity capable of managing its lifecycle autonomously and securely.

The process begins with receiving a request to create a self-determinative document. This step initiates the transformation of a static file into a document provisioned with embedded intelligence. Traditional systems rely on external tools and manual processes to manage documents, leading to inefficiencies, inconsistencies, and security vulnerabilities. The creation of a self-determinative document eliminates these issues by embedding intelligence directly into the document, enabling it to perform actions autonomously and interact with external systems seamlessly. This embedded intelligence is achieved through the integration of executable code, metadata, and machine-readable content, which together form the “brain” of the document. The document's intelligence allows it to process requests, enforce access controls, track interactions, and adapt its behavior based on contextual factors.

The provisioning of embedded intelligence enables the document to achieve self-determination, addressing the technical problem of static and inflexible document formats. Traditional documents, such as PDFs, are designed for human visual consumption and lack the ability to adapt to changing contexts or user needs. Self-determinative documents overcome this limitation by incorporating dynamic rendering capabilities, allowing them to tailor user experiences based on interactions and preferences. For example, the document can reflow text to accommodate changes in font size, provide read-aloud functionality, or adjust its layout for optimal readability on different devices. These capabilities ensure that the document remains accessible and usable across diverse environments while maintaining its integrity and consistency.

The method further involves receiving data to store within the self-determinative document via its embedded intelligence. This step addresses the technical problem of fragmented and inconsistent data storage in traditional systems. By storing data directly within the document, the method ensures that the document serves as a single source of truth, eliminating duplication and maintaining consistency. The document's machine-readable format allows it to organize and structure the data semantically, enabling advanced computational interactions and precise data extraction. For example, the document can store financial metrics, contractual clauses, or user activity logs as structured data, making them accessible and actionable for both human users and machine systems. This capability enhances the document's utility and ensures that its data remains reliable and secure.

The final step of the method involves providing remote access to the data via the embedded intelligence. This capability addresses the technical problem of limited accessibility and control in traditional document systems. By enabling remote access, the self-determinative document ensures that users and systems can interact with its content and functionality from anywhere, without compromising security or integrity. The document's embedded intelligence allows it to enforce granular access controls, ensuring that only authorized parties can view, edit, or share specific sections. For example, the document can restrict access to sensitive clauses in a contract based on user roles or security clearances, while allowing full access for authorized stakeholders. This capability enhances security and compliance, ensuring that the document remains trustworthy and reliable throughout its lifecycle.

The method also leverages the immutable structure of self-determinative documents to address the technical problem of tampering and inconsistency. The document's content and audit trail are cryptographically secured, ensuring that they remain unchanged and trustworthy. When the document is created, its content is hashed to produce a unique cryptographic fingerprint, which serves as a reference for verifying its integrity. Any attempt to modify the content results in a mismatch between the original hash and the altered data, signaling tampering. Additionally, the document may be digitally signed using the creator's private key, providing cryptographic proof of its authenticity and origin. These measures ensure that the document remains secure and reliable, even in complex workflows involving multiple stakeholders.

The immutable audit trail further enhances the document's ability to address technical problems related to transparency and accountability. The audit trail records every interaction with the document, including access attempts, modifications, approvals, and other events. Each event is cryptographically secured and timestamped, creating a tamper-proof history of the document's lifecycle. This audit trail enables users and systems to analyze the document's interactions, verify compliance with regulatory requirements, and resolve disputes based on a reliable record of events. The audit trail is linked to the document's content and global marker, ensuring that all recorded events are associated with the correct document.

The permanent global marker embedded in the document's metadata ensures that the document can always be referenced and retrieved in its original form. This marker serves as a unique and unchanging identifier, eliminating ambiguity and enabling seamless integration with external systems. The global marker allows the document to maintain a single source of truth, ensuring that its data and interactions remain consistent and reliable across diverse platforms and applications.

Self-determinative documents solve the problems of data security, inefficient use of device hardware, and inefficient use of network systems associated with traditional PDFs by leveraging their immutable structure, embedded intelligence, and machine-readable design. In terms of data security, the document's cryptographic commitments ensure that its content, audit trail, and global identifier remain tamper-proof and trustworthy, eliminating vulnerabilities inherent in PDFs, which often rely on external systems for encryption and access control. The embedded intelligence within self-determinative documents autonomously enforces granular access permissions, reducing the risk of unauthorized access, ensuring compliance with security protocols, and dynamically adapting to changing user roles or security requirements.

Regarding device hardware, traditional PDFs require significant computational resources for rendering, extracting data, and managing versions, often leading to inefficiencies and hardware strain. Self-determinative documents, with their machine-readable format, eliminate the need for complex text extraction algorithms and redundant processing, optimizing the use of device hardware and enabling faster, more efficient operations. Similarly, network systems that handle PDFs often experience bandwidth inefficiencies due to the need to transmit large, static files and duplicate versions. Self-determinative documents address this by maintaining a single source of truth that is universally accessible via their global identifier, reducing the need to transmit entire files and instead enabling lightweight, API-driven interactions. This approach minimizes network bandwidth usage, streamlines workflows, and ensures that documents are securely and efficiently managed across devices and systems.

By leveraging the features of self-determinative documents, the methods described here address technical problems related to document management, security, and accessibility. The creation of a self-determinative document with embedded intelligence transforms the document into a dynamic and interactive entity capable of managing its lifecycle autonomously. The storage of data within the document ensures consistency and reliability, while remote access enables seamless interaction and control. The immutable structure and global marker provide security, transparency, and accountability, ensuring that the document remains trustworthy and reliable throughout its lifecycle. This method redefines the role of digital documents, offering a solution that integrates content, context, and intelligence to create a robust framework for modern workflows.

Aspects of this disclosure address the technical problem of maintaining control and security over electronic documents once they have been shared beyond their original digital perimeter. In traditional document management systems, once a document is distributed, the original owner or creator loses control over how the document is accessed, shared, or modified. This lack of control can lead to unauthorized dissemination, security breaches, and potential exposure of sensitive information. Existing methods often rely on static security measures, such as passwords or encryption, which do not provide dynamic control or real-time monitoring capabilities. These methods are insufficient for managing documents across diverse platforms and devices, where the risk of unauthorized access and data leakage is high.

Aspects described herein provide a technical solution by introducing a computer-implemented method that provisions the document as self-determinative, embedding an API within the document itself. This API enables the document to function as a smart digital object, allowing for remote management and control. The method includes storing data within the document, receiving access requests, determining authorization, and controlling access—all executed by the document. This approach ensures that the document's owner can maintain control over the document's content, manage access permissions dynamically, and monitor interactions in real-time, regardless of the document's location or the number of copies in existence. By transforming the document into an active, controllable entity, the examples disclosed herein provide a robust solution to the challenges of document security and control in modern digital environments.

Some aspects enhance the function of computing device hardware and networks by transforming the way electronic documents are managed, accessed, and controlled, thereby improving efficiency, security, and resource utilization. By provisioning the document as self-determinative, the computing device gains the ability to manage documents as smart digital objects. This transformation allows for remote control and management of the document, enabling the device to enforce access permissions, track interactions, and maintain document integrity even after distribution.

For computing device hardware, the embedded API allows the device to dynamically manage access to the document, reducing the need for manual intervention and minimizing processing overhead. This capability ensures that the device can adapt to changing security requirements and organizational policies, providing a more responsive and secure document management system. The API also facilitates seamless integration with other systems and applications, allowing the device to interact with a broader digital ecosystem without compatibility issues. This integration supports enhanced functionalities such as automated workflows, data synchronization, and collaborative features, expanding the device's utility and efficiency in managing digital documents.

For networks, the solution reduces bandwidth consumption and optimizes data transmission by maintaining a single source of truth for each document. Instead of distributing multiple copies, the document is accessed and managed through a centralized system, ensuring consistency and reducing redundancy. This approach minimizes network load and enhances data integrity, allowing for more efficient use of network resources. Additionally, the ability to monitor document interactions in real-time provides immediate feedback on access attempts and changes, enhancing network security by enabling quick detection and response to unauthorized access or tampering.

Other aspects of this disclosure address the technical problem of managing multiple copies of the same document across different platforms and users, which can lead to inconsistencies, data redundancy, and security vulnerabilities. This proliferation of document copies can make it difficult to ensure that all users have the correct version and appropriate access rights, potentially leading to unauthorized access or data breaches. Additionally, determining and managing access rights for multiple users across various copies of a document can be complex and error-prone, especially in large organizations with diverse user roles and permissions.

Some aspects provide a technical solution for this problem by performing a deduplication process, identifying additional copies of the existing document within the plurality of documents to maintain a single true copy. The aspects of managing document duplication and access rights significantly enhance the functionality of computing device hardware and networks by optimizing resource utilization and improving security protocols. This approach reduces data redundancy, ensuring that only one authoritative version of a document exists, which minimizes storage requirements and processing overhead on the hardware. The deduplication process further enhances network efficiency by reducing unnecessary data transmission. This streamlined approach ensures that network resources are used more effectively, allowing for quicker access to documents and reducing latency in data exchanges.

Additionally, the ability to dynamically adjust access controls based on identified access rights enhances the security framework of both the computing device and the network. By ensuring that only authorized users can access specific documents, the system reduces the risk of unauthorized access and potential data breaches. This capability allows the computing device to enforce security policies more effectively, while the network benefits from enhanced protection against unauthorized data transmission.

In conclusion, the embodiments described herein represent a significant advancement in document management technology, transforming traditional documents into self-determinative entities capable of autonomous operation. By embedding intelligence within documents, these systems enable dynamic interaction, robust security, and seamless integration with existing digital ecosystems. The ability to manage documents as smart digital objects addresses the limitations of conventional document handling, offering enhanced control, flexibility, and efficiency. Whether through instant transformation, advanced access control, or integration with AI systems, these examples may provide a solution for modern document management challenges. As organizations continue to navigate the complexities of digital information exchange, the adoption of self-determinative documents promises to streamline processes, safeguard sensitive data, and empower users with control over their digital assets.

Clause 1. A method comprising: receiving a request to create a self-determinative document; creating, in response to the request, the self-determinative document by provisioning, to the self-determinative document, embedded intelligence that enables self-determination of the document; receiving, via the embedded intelligence, data to store within the self-determinative document; and providing, via a computing system executing the embedded intelligence, remote access to the data via the embedded intelligence.

Clause 2. The method of clause 1, wherein: the request to create the self-determinative document comprises a request to convert an existing document that comprises a data file into the self-determinative document; and receiving the data to store within the self-determinative document comprises copying, via the embedded intelligence, the data into the self-determinative document.

Clause 3. The method of clauses 1-2, further comprising deleting the existing document after copying the data of the existing document to the self-determinative document.

Clause 4. The method of clauses 1-3, further comprising: receiving a request to recover the deleted document; and providing, in response to the request to recover the deleted document, access to the data via a recreated document that has a same file type as the deleted document.

Clause 5. The method of clauses 1-4, wherein: the request to convert the existing document comprises a request to identify, within a file management system, a plurality of documents for conversion; and the plurality of documents comprises the existing document.

Clause 6. The method of clauses 1-5, further comprising: performing a deduplication process by: identifying an additional copy of the existing document within the plurality of documents; determining that the existence of the additional copy of the existing document is indicative of an additional access right to the data of the existing document; and enabling, via the embedded intelligence of the self-determinative document, the additional access right to the data.

Clause 7. The method of clauses 1-6, wherein the request to convert the existing document is triggered automatically when the document is opened.

Clause 8. The method of clauses 1-7, wherein: the request to create the self-determinative document comprises a request to include a portion of data of an existing document in the self-determinative document and to leave a different portion of the data of the existing document within the existing document; and receiving the data to store within the self-determinative document comprises receiving the portion of the data of the existing document.

Clause 9. The method of clauses 1-8, wherein the request to create the self-determinative document comprises a request to create a new self-determinative document that is not based on an existing document.

Clause 10. A system comprising: one or more physical processors; physical memory comprising computer-executable instructions that, when executed by the physical processor, cause at least one of the one or more physical processors to: receive a request to create a self-determinative document; provision, in response to the request, the self-determinative document by embedding intelligence that enables self-determination of the document, wherein the embedded intelligence is programmed to cause at least one of the one or more physical processors to: receive data to store within the self-determinative document; and provide remote access to the data.

Clause 11. The system of clause 10, wherein: the request to create the self-determinative document comprises a request to convert an existing document that comprises a data file into the self-determinative document; and the embedded intelligence is programmed to copy the data into the self-determinative document.

Clause 12. The system of clauses 10-11, wherein the system is further configured to delete the existing document after copying the data of the existing document to the self-determinative document.

Clause 13. The system of clauses 10-12, wherein the system is further configured to: receive a request to recover the deleted document; and provide, in response to the request to recover the deleted document, access to the data via a recreated document that has a same file type as the deleted document.

Clause 14. The system of clauses 10-13, wherein: the request to convert the existing document comprises a request to identify, within a file management system, a plurality of documents for conversion; and the plurality of documents comprises the existing document.

Clause 15. The system of clauses 10-14, wherein the system is further configured to perform a deduplication process by: identifying an additional copy of the existing document within the plurality of documents; determining that the existence of the additional copy of the existing document is indicative of an additional access right to the data of the existing document; and enabling, via the embedded intelligence of the self-determinative document, the additional access right to the data.

Clause 16. The system of clauses 10-15, wherein the request to convert the existing document is triggered automatically when the document is opened.

Clause 17. The system of clauses 10-16, wherein: the request to create the self-determinative document comprises a request to include a portion of data of an existing document in the self-determinative document and to leave a different portion of the data of the existing document within the existing document; and the embedded intelligence is configured to cause at least one of the one more processors to receive the portion of the data of the existing document.

Clause 18. The system of clauses 10-17, wherein the request to create the self-determinative document comprises a request to create a new self-determinative document that is not based on an existing document.

Clause 19. A non-transitory computer-readable medium comprising computer-executable instructions that, when executed by at least one of one or more processors of a computing device, cause the computing device to: receive a request to create a self-determinative document; provision, in response to the request, the self-determinative document by embedding intelligence that enables self-determination of the document, wherein the embedded intelligence is configured to cause at least one of the one or more processors to: store the data within the self-determinative document; and provide, via a computing system executing the embedded intelligence, remote access to the data.

Clause 20. The non-transitory computer-readable medium of clause 19, wherein: the request to create the self-determinative document comprises a request to convert an existing document that comprises a data file into the self-determinative document; and the embedded intelligence is configured to cause at least one of the one or more processor to copy the data into the self-determinative document.

Clause 21. The non-transitory computer-readable medium of clauses 19-20, wherein the computer-readable medium is further configured to cause the one or more processors to delete the existing document after copying the data of the existing document to the self-determinative document.

Clause 22. The non-transitory computer-readable medium of clauses 19-21, wherein the computer-executable instructions are further configured to cause at least one of the one or more processors to: receive a request to recover the deleted document; and provide, in response to the request to recover the deleted document, access to the data via a recreated document that has a same file type as the deleted document.

Clause 23. The non-transitory computer-readable medium of clauses 19-22, wherein the request to convert the existing document comprises a request to identify, within a file management system, a plurality of documents for conversion, and the plurality of documents comprises the existing document.

Clause 24. The non-transitory computer-readable medium of clauses 19-23, wherein the computer-executable instructions are further configured to cause the at least one of the one or more processors to perform a deduplication process by: identifying an additional copy of the existing document within the plurality of documents; determining that the existence of the additional copy of the existing document is indicative of an additional access right to the data of the existing document; and enabling, via the embedded intelligence of the self-determinative document, the additional access right to the data.

Clause 25. The non-transitory computer-readable medium of clauses 19-24, wherein the request to convert the existing document is triggered automatically when the document is opened.

Clause 26. The non-transitory computer-readable medium of clauses 19-25, wherein: the request to create the self-determinative document comprises a request to include a portion of data of an existing document in the self-determinative document and to leave a different portion of the data of the existing document within the existing document; and the computer-executable instructions are further configured to cause the at least one or more processors to receive the portion of the data of the existing document.

Clause 27. The non-transitory computer-readable medium of clauses 19-26, wherein the request to create the self-determinative document comprises a request to create a new self-determinative document that is not based on an existing document.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving a request to create a self-determinative document;
creating, in response to the request, the self-determinative document by provisioning, to the self-determinative document, embedded intelligence that enables self-determination of the document;
receiving, via the embedded intelligence, data to store within the self-determinative document; and
providing, via a computing system executing the embedded intelligence, remote access to the data via the embedded intelligence.

2. The method of claim 1, wherein:
the request to create the self-determinative document comprises a request to convert an existing document that comprises a data file into the self-determinative document; and
receiving the data to store within the self-determinative document comprises copying, via the embedded intelligence, the data into the self-determinative document.

3. The method of claim 2, further comprising deleting the existing document after copying the data of the existing document to the self-determinative document.

4. The method of claim 3, further comprising:
receiving a request to recover the deleted document; and
providing, in response to the request to recover the deleted document, access to the data via a recreated document that has a same file type as the deleted document.

5. The method of claim 2, wherein:
the request to convert the existing document comprises a request to identify, within a file management system, a plurality of documents for conversion; and
the plurality of documents comprises the existing document.

6. The method of claim 5, further comprising:
performing a deduplication process by:
identifying an additional copy of the existing document within the plurality of documents;
determining that the existence of the additional copy of the existing document is indicative of an additional access right to the data of the existing document; and
enabling, via the embedded intelligence of the self-determinative document, the additional access right to the data.

7. The method of claim 2, wherein the request to convert the existing document is triggered automatically when the document is opened.

8. The method of claim 1, wherein:
the request to create the self-determinative document comprises a request to include a portion of data of an existing document in the self-determinative document and to leave a different portion of the data of the existing document within the existing document; and
receiving the data to store within the self-determinative document comprises receiving the portion of the data of the existing document.

9. The method of claim 1, wherein the request to create the self-determinative document comprises a request to create a new self-determinative document that is not based on an existing document.

10. The method of claim 1, wherein the self-determinative document is configured to maintain a single source of truth within a network.

11. The method of claim 1, wherein the self-determinative document is configured to manage its own lifecycle.

12. The method of claim 1, wherein the self-determinative document is configured to ensure that an artificial intelligence agent can interact only with content relevant to tasks of the artificial intelligence agent in a manner that reduces a risk of unauthorized data exposure.

13. The method of claim 1, wherein the self-determinative document is configured to interact with an artificial intelligence agent using a specialized protocol.

14. The method of claim 13, wherein the specialized protocol comprises a machine communication protocol.

15. The method of claim 1, wherein the self-determinative document enables artificial intelligence analysis of engagement with the self-determinative document.

16. The method of claim 1, wherein embedded intelligence of the self-determinative document is configured to provide one or more insights that inform artificial intelligence training.

17. A system comprising:
one or more physical processors;
physical memory comprising computer-executable instructions that, when executed by the physical processor, cause at least one of the one or more physical processors to:
receive a request to create a self-determinative document;
provision, in response to the request, the self-determinative document by embedding intelligence that enables self-determination of the document, wherein the embedded intelligence is programmed to cause at least one of the one or more physical processors to:
receive data to store within the self-determinative document; and
provide remote access to the data.

18. The system of claim 17, wherein:
the request to create the self-determinative document comprises a request to convert an existing document that comprises a data file into the self-determinative document; and
the embedded intelligence is programmed to copy the data into the self-determinative document.

19. The system of claim 18, wherein the system is further configured to delete the existing document after copying the data of the existing document to the self-determinative document.

20. The system of claim 19, wherein the system is further configured to:
receive a request to recover the deleted document; and
provide, in response to the request to recover the deleted document, access to the data via a recreated document that has a same file type as the deleted document.

21. The system of claim 18, wherein:
the request to convert the existing document comprises a request to identify, within a file management system, a plurality of documents for conversion; and
the plurality of documents comprises the existing document.

22. The system of claim 21, wherein the system is further configured to perform a deduplication process by:
identifying an additional copy of the existing document within the plurality of documents;
determining that the existence of the additional copy of the existing document is indicative of an additional access right to the data of the existing document; and
enabling, via the embedded intelligence of the self-determinative document, the additional access right to the data.

23. The system of claim 18, wherein the request to convert the existing document is triggered automatically when the document is opened.

24. The system of claim 17, wherein:
the request to create the self-determinative document comprises a request to include a portion of data of an existing document in the self-determinative document and to leave a different portion of the data of the existing document within the existing document; and
the embedded intelligence is configured to cause at least one of the one more processors to receive the portion of the data of the existing document.

25. The system of claim 17, wherein the request to create the self-determinative document comprises a request to create a new self-determinative document that is not based on an existing document.

26. A non-transitory computer-readable medium comprising computer-executable instructions that, when executed by at least one of one or more processors of a computing device, cause the computing device to:
receive a request to create a self-determinative document;
provision, in response to the request, the self-determinative document by embedding intelligence that enables self-determination of the document, wherein the embedded intelligence is configured to cause at least one of the one or more processors to:
store data within the self-determinative document; and
provide, via a computing system executing the embedded intelligence, remote access to the data.

27. The non-transitory computer-readable medium of claim 26, wherein:
the request to create the self-determinative document comprises a request to convert an existing document that comprises a data file into the self-determinative document; and
the embedded intelligence is configured to cause at least one of the one or more processors to copy the data into the self-determinative document.

28. The non-transitory computer-readable medium of claim 27, wherein the computer-readable medium is further configured to cause the one or more processors to delete the existing document after copying the data of the existing document to the self-determinative document.

29. The non-transitory computer-readable medium of claim 28, wherein the computer-executable instructions are further configured to cause at least one of the one or more processors to:
receive a request to recover the deleted document; and
provide, in response to the request to recover the deleted document, access to the data via a recreated document that has a same file type as the deleted document.

30. The non-transitory computer-readable medium of claim 27, wherein the request to convert the existing document comprises a request to identify, within a file management system, a plurality of documents for conversion, and the plurality of documents comprises the existing document.

31. The non-transitory computer-readable medium of claim 30, wherein the computer-executable instructions are further configured to cause the at least one of the one or more processors to perform a deduplication process by:
identifying an additional copy of the existing document within the plurality of documents;
determining that the existence of the additional copy of the existing document is indicative of an additional access right to the data of the existing document; and
enabling, via the embedded intelligence of the self-determinative document, the additional access right to the data.

32. The non-transitory computer-readable medium of claim 27, wherein the request to convert the existing document is triggered automatically when the document is opened.

33. The non-transitory computer-readable medium of claim 26, wherein:
the request to create the self-determinative document comprises a request to include a portion of data of an existing document in the self-determinative document and to leave a different portion of the data of the existing document within the existing document; and
the computer-executable instructions are further configured to cause the at least one or more processors to receive the portion of the data of the existing document.

34. The non-transitory computer-readable medium of claim 26, wherein the request to create the self-determinative document comprises a request to create a new self-determinative document that is not based on an existing document.
